(19) United States
(12) Patent Application Publication
(10) Pub. No.: US 2005/0181746 A1
(43) Pub. Date: Aug. 18, 2005

(54) Methods and systems for signal amplification through envelope removal and restoration

(75) Inventor: James Stuart Wight, Ottawa (CA)

Correspondence Address: TESTA, HURWITZ & THIBEAULT, LLP, HIGH STREET TOWER, 125 HIGH STREET, BOSTON, MA, 02110, US

(73) Assignee: IceFyre Semiconductor Corporation, Kanata (CA)

(21) Appl. No.: 10/779,322

(22) Filed: Feb. 13, 2004

(51) Int. Cl. H04B 1/02

(52) U.S. Cl. 455/91; 455/114.3; 455/114.2

(57) ABSTRACT

Embodiments of the present invention comprise systems, methods, and devices for amplifying electromagnetic signals by decomposing each signal into a plurality of near-constant envelope signals, removing residual amplitude modulation from these signals, amplifying each signal independently, and recombining the amplified signals. In the preferred embodiment a plurality of control signals, each corresponding to the magnitude of a respective near-constant envelope signal, is employed to amplify each near-constant envelope signal in inverse proportion to its corresponding control signal. This inverse amplification preferably eliminates any unwanted residual amplitude modulation thus producing an amplified constant envelope signal. The plurality of amplified constant envelope signals is then preferably combined to form an amplified version of the incoming signal.

### FIELD OF THE INVENTION

The present invention relates generally to amplification of signals, and more specifically to amplification and subsequent recombination of a decomposed signal.

### BACKGROUND OF THE INVENTION

Radio Frequency (RF) transmitters typically use an RF Power Amplifier (PA) to provide the RF signal strength needed for radio communications over a distance. The output of the PA is typically provided to a transmitting antenna, and thus the power output of the PA is proportional to the transmitted power. As the output power of the PA increases, the power radiated by the transmitting antenna increases and the useable range of the transmitter increases.

In most RF transmitters, the PA handles the largest power within the transmitter and inefficiency in the PA typically accounts for much of the wasted power in the transmitter. Unfortunately, in many applications, the PA does not perform the task of power amplification efficiently, consuming much more power than is actually transmitted. This excess power generation can be costly, especially in battery operated devices, because it often necessitates the use of larger-capacity batteries, and/or shorter battery recharging intervals.

A PA may be designed to amplify an RF signal with a constant envelope or an RF signal with a non-constant envelope. A PA designed for constant envelope signals is typically more efficient than a PA designed for a non-constant envelope signal because the biasing circuits in the constant envelope PA can be optimized to deliver the constant power level. Moreover, if perfect envelope magnitude fidelity is not required, the PA circuits can be driven slightly into compression (nonlinearity), which offers even further efficiency gains. Unfortunately, as the PA is driven into compression, the signal spectrum tends to widen, due to nonlinear distortions. These nonlinear distortions produce intermodulation products, which arise when signals of differing frequencies pass through a nonlinearity. This spectral widening is called spectral regrowth, and is undesirable because it spills RF energy into adjacent frequency channels. The energy spilled into other channels is known as Adjacent Channel Power (ACP) emissions and is often undesirable because it may cause interference with communication systems operating in the other channels. Thus, tradeoffs exist between efficiency and ACP emissions, even for constant-envelope PAs. Typically, regulations on RF transmitters and communication systems specify an acceptable Adjacent Channel Power Ratio (ACPR). The ACPR is the ratio of the average power in the active channel passband to the average power spilled into an adjacent channel passband or some fraction of the adjacent channel passband.

Non-constant envelope signals, such as Differential Quadrature Phase Shift Keying (DQPSK) and spread spectrum signals, make the PA efficiency problem even more difficult because the modulation may cause the amplitude of the envelope to vary by 14 dB or more. Moreover, the peak-to-average power values may run from 3 dB, as in π/4 DQPSK, to 17 dB for some OFDM systems. Peak-to-average power is important because clipping occurs when the peak-power capabilities of the PA are exceeded, and clipping introduces much distortion. Most systems are biased so that the PA runs at near saturation when the amplitude of the envelope is at a maximum, corresponding to peak power output. To become even more efficient, some systems push the peak power output into saturation, but this can result in unacceptable ACP emissions. This push into saturation can also cause distortions in the in-band modulation accuracy, which is called Error-Vector Modulation (EVM) accuracy, and is specified in terms of RMS error from an ideally modulated signal. To realize good ACP and EVM figures, transmitters that drive the PA into saturation often pre-distort those sections of the input envelope which would be compressed during saturation, so that the resulting output is an undistorted facsimile of the input. Unfortunately, most saturation regions are narrow (often less than the 3 dB peak-to-average criterion given above for π/4 DQPSK), and thus only allow modest pre-distortion (and efficiency) improvements.

Prior art PA designs are particularly inefficient when operating at less than full output power, as is common in systems that use adaptive power control. With adaptive power control the system controls the output power of the PA such that the PA provides only as much output power as is needed to provide good communications. Adaptive power control is useful because it extends battery life, by transmitting with no more power than needed, and, at the same time, increases a communication system's capacity, by reducing the interference among users. However, many of the desired gains promised by adaptive power control have not been realized because the power saved by transmitting at reduced power is lost because the overall PA is less efficient at reduced power.

A promising PA design uses the principle of Linear Amplification with Non-Linear Components (LINC), whereby an incoming signal having both amplitude and phase variation is decomposed into two component signals, each having constant amplitude and with variations in phase only. Each constant amplitude component signal is amplified and then the amplified constant amplitude signals are recombined to form an amplified version of the original signal. However, a key problem in LINC amplification is that the band limiting and quantization effects in the decomposition process produces component signals having residual amplitude modulation. Thus the component signals are not constant envelope signals, but rather near-constant envelope signals, and as a result the amplification is inaccurate.

### SUMMARY OF THE INVENTION

Thus a need exists for an amplification system, capable of amplifying, among other things, wireless communication signals with greater efficiency and accuracy than that found in the prior art. In satisfaction of these needs, embodiments of the present invention comprise systems, methods, and devices for amplifying electromagnetic signals by decomposing each signal into a plurality of near-constant envelope signals, removing residual amplitude modulation from these signals, thereby creating a constant envelope signal; amplifying each signal independently, and recombining the amplified constant envelope signals. In the preferred embodiment a plurality of control signals, each corresponding to the magnitude of a respective near-constant envelope signal, is employed to amplify each near-constant envelope signal in inverse proportion to its corresponding control signal. This inverse amplification preferably eliminates any unwanted residual amplitude modulation thus producing an amplified constant envelope signal. The plurality of amplified constant envelope signals is then preferably combined to form an amplified version of the incoming original signal.

In accordance with one aspect of the invention, a method is provided for amplifying a signal. This method includes decomposing a signal into a plurality of near-constant envelope signals, producing a plurality of control signals, where each control signal corresponds to the magnitude of a respective near-constant envelope signal, and then amplifying each near-constant envelope signal in inverse proportion to its corresponding control signal. In various embodiments of this method, the plurality of inversely amplified near-constant envelope signals is then combined to produce an amplified output signal. In some embodiments, decomposing the signals is performed via LINC signal decomposition. Embodiments of this method may also include using an adjustable gain amplifier to amplify each near-constant signal. Additionally, some embodiments of this method use a Chireix style amplitude combiner to combine the signals, while other embodiments use a conventional power combiner.

In accordance with another aspect of the invention, a system is provided for amplifying a signal including a means for decomposing a signal into a plurality of near-constant envelope signals, a means for measuring the amplitude of each near-constant envelope signal to obtain a plurality of respective control signals, a plurality of variable amplification means for amplifying each near-constant envelope signal, and a means for combining signals. The bias of each variable amplification means is adjusted to amplify each near-constant envelope signal in inverse proportion to its respective control signal, thereby producing a corresponding inversely amplified constant envelope signal. Additionally, the combining means combines the plurality of amplified constant envelope signals. In some embodiments, the decomposing means comprises LINC signal decomposition. Also, in some embodiments the combining means comprises a Chireix style amplitude combiner, while in other embodiments it comprises a conventional power combiner.

In accordance with yet another aspect of the invention, a device is provided for amplifying a signal. The device includes a signal decomposer, a plurality of amplified envelope detectors, a plurality of adjustable gain amplifiers, and a combiner. The signal decomposer of the device fragments a signal into a plurality of near-constant envelope signals, and each amplified envelope detector produces a control signal corresponding to a respective near-constant envelope signal. Next, the gain of each adjustable gain amplifier is controlled by respective gain controlled signal and each adjustable gain amplifier amplifies a respective near-constant envelope signal with gain inversely proportionate to its respective control signal, thereby producing an inversely amplified constant envelope signal. Finally, the combiner is configured to combine the plurality of amplified constant envelope signals. In some embodiments, the signal decomposer comprises a LINC signal decomposer. Also, in some embodiments the combiner comprises a Chireix style amplitude combiner, while in other embodiments it comprises a conventional power combiner.

### BRIEF DESCRIPTION OF DRAWINGS

These and other aspects of this invention will be readily apparent from the detailed description below and the appended drawings, which are meant to illustrate and not to limit the invention, and in which:

FIG. 1 presents an embodiment of the present invention incorporating a feed forward loop;

FIG. 2 illustrates an embodiment of the present invention incorporating a feedback loop;

FIG. 3 illustrates a method in accord with an embodiment of the present invention.

In the drawings, like reference characters generally refer to corresponding parts throughout the different views.

### DETAILED DESCRIPTION OF THE INVENTION

In brief overview embodiments of the present invention amplify an incoming signal by first decomposing the signal into a plurality of near-constant envelope signals. Ideally, this decomposition should produce a plurality of constant envelope signals, but due to band limiting and quantization effects in the decomposition process, the output signals retain a residual amplitude modulation and are hence described as near-constant envelope signals. Embodiments of the present invention also produce a plurality of control signals, each corresponding to the magnitude of a respective near-constant envelope signal. The plurality of control signals are used to amplify each near-constant envelope signal in inverse proportion to its corresponding control signal. This inverse amplification eliminates the unwanted residual amplitude modulation thus producing an amplified constant envelope signal. The plurality of amplified constant envelope signals can then be combined to form an amplified version of the incoming signal.

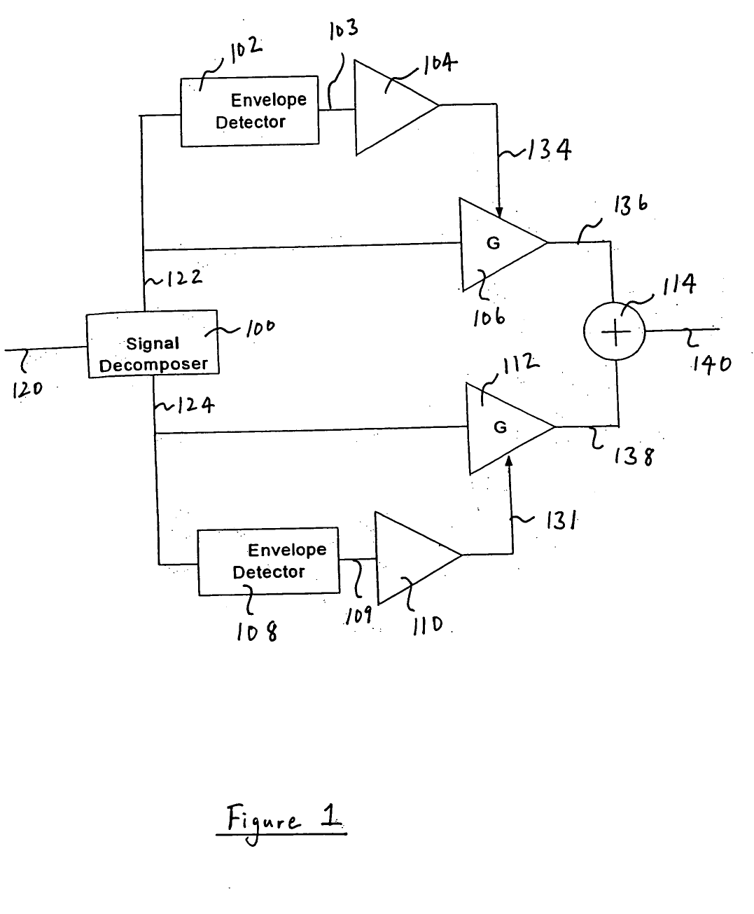

FIG. 1 presents an embodiment of the present invention incorporating feed forward loops. As illustrated in FIG. 1, this embodiment preferably comprises a signal decomposer 100, a first envelope detector 102, a first amplifier 104, a first adjustable gain amplifier 106, a second envelope detector 108, a second amplifier 110, a second adjustable gain amplifier 112, and a combiner 114.

Preferably, signal decomposer 100 has at least one input and at least two outputs. In this embodiment, line 120 is used for data input into signal decomposer 100. Lines 122 and 124 are used for data output from signal decomposer 100. Line 122 connects signal decomposer 100 with both the input of first envelope detector 102 and the input of first adjustable gain amplifier 106. The output of first envelope detector 102 is in turn connected via line 103 to the input of first amplifier 104, and the first amplifier 104 output is connected via line 134 to a control input of first adjustable gain amplifier 106. The output of first adjustable gain amplifier 106 is then preferably connected to an input of the signal combiner 114 by line 136. In alternate embodiments an additional power amplifier may be inserted between the first adjustable gain amplifier 106 and the combiner 114.

In this embodiment, line 124 is used for data output from signal decomposer 100, and is preferably connected to both the input of second envelope detector 108 and the input of second adjustable gain amplifier 112. The output of second envelope detector 108 is in turn connected via line 109 to the input of second amplifier 110, and the second amplifier 110 output is connected via line 131 to a control input of second adjustable gain amplifier 112. The output of second adjustable gain amplifier 112 is then preferably connected to a second input of signal combiner 114 by line 138. In addition, another power amplifier may optionally be inserted between the second adjustable gain amplifier 112 and the combiner 114.

Signal combiner 114 preferably comprises at least two inputs and at least one output. As described above, lines 136 and 138 are preferably used for input to signal combiner 114. Line 140 is preferably used for output from signal combiner 114.

In the preferred embodiment, the signal decomposer 100 comprises a LINC signal decomposer. However, one skilled in the art will readily appreciate that the signal decomposer may comprise any device capable of decomposing a signal into a plurality of components. Also in the preferred embodiment, the envelope detectors 102 and 108 can comprise any device which detects the envelope of an incoming signal including, for example a digital signal processor (DSP) or a traditional diode-capacitor envelope detector. Furthermore, the amplifiers 104 and 110 are employed preferably for the purpose of amplifying the envelope portion of an input signal to a range acceptable for input to adjustable gain amplifiers 106 and 112. Accordingly, one skilled in the art will recognize that in alternate embodiments where an envelope detector outputs an envelope signal already in the range of the adjustable gain amplifiers 106, 112, the amplifiers 104 and 110 are unnecessary and are optional.

Also in the preferred embodiment, combiner 114 comprises a Chireix style amplitude combiner. In various other embodiments, combiner 114 can also comprise a conventional power combiner.

In operation, a signal is received from input line 120 by signal decomposer 100 and is decomposed into two near-constant envelope signal components. These two near-constant signals are then transmitted from signal decomposer 100 to envelope detectors 102 and 108 respectively, and also to adjustable gain amplifier 106 and 112 respectively. Signal decomposer 100 need not be limited to decomposing a signal into merely two components. In various embodiments, signal decomposer 100 may decompose signal 100 into a plurality of near-constant components, and then output each near-constant component to a plurality of respective envelope detectors.

In the preferred embodiment, a first near-constant envelope signal is transmitted to the first adjustable gain amplifier 106. This near-constant envelope signal is also transmitted to first envelope detector 102 where the envelope portion of the near-constant envelope signal is preferably determined and transmitted to first amplifier 104. In this embodiment, first amplifier 104, in turn, amplifies the envelope portion of the first near-constant envelope signal and then transmits the amplified envelope to adjustable first gain amplifier 106.

The first adjustable gain amplifier 106 then preferably amplifies the first near-constant envelope signal received at line 122 in inverse proportion to its amplified envelope, which is received via line 134. By amplifying the first near-constant envelope signal in inverse proportion to its amplified envelope, most, and preferably all, of the residual amplitude modulation in the near-constant envelope signal is removed, producing an amplified constant envelope signal at output line 136. Thus, the amplified constant envelope signal output at line 136 is preferably an amplified version of the first near-constant envelope signal, but with either reduced or completely removed residual amplitude modulation.

In a process symmetrical to that undergone above by the first near-constant envelope signal, a second near-constant envelope signal is transmitted from signal decomposer 100 to second envelope detector 108 and also to second adjustable gain amplifier 112 along line 124. Second envelope detector 108 extracts the envelope portion of the second near-constant envelope signal and then transmits this envelope portion to second amplifier 110. Second amplifier 110, in turn, amplifies the envelope portion of the second near-constant envelope signal and then transmits the amplified envelope to second adjustable gain amplifier 112 along line 131.

Second adjustable gain amplifier 112 then preferably amplifies the second near-constant envelope signal in inverse proportion to its amplified envelope, which is received via line 131. By amplifying the second near-constant envelope signal in inverse proportion to its amplified envelope, most, and preferably all, of the residual amplitude modulation in the near-constant envelope signal is removed and the product is an amplified constant envelope signal at output along line 138. Thus, the amplified constant envelope signal that is output on line 138 is preferably an amplified version of the second near-constant envelope signal, but with either reduced or, most preferably, completely removed residual amplitude modulation.

Finally, the amplified constant signals are both transmitted along lines 137 and 138 to combiner 114 where the two signals are combined to produce an output signal which is output to line 140. Combiner 114 may be any type of device capable of combining two or more signals to form an output signal. However, in the preferred embodiment, combiner 114 comprises a Chireix style amplitude combiner. In some embodiments, combiner 114 may also comprise a conventional power combiner. As the output signal from combiner 114 preferably comprises the combination of the amplified components of the incoming signal along line 120, the signal output on line 140 comprises an amplified version of the incoming signal on line 120.

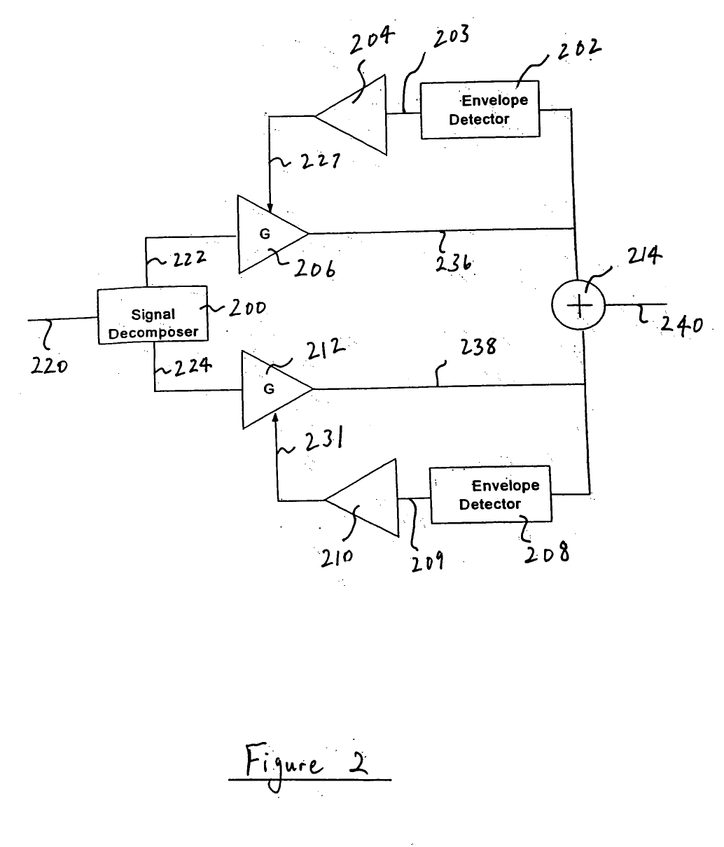

FIG. 2 illustrates an embodiment of the present invention incorporating feedback loops. As shown in FIG. 2, this embodiment preferably comprises a signal decomposer 200, a first envelope detector 202, a first amplifier 204, a first adjustable gain amplifier 206, a second envelope detector 208, a second amplifier 210, a second adjustable gain amplifier 212, and a combiner 214.

Preferably, signal decomposer 200 comprises at least one input and at least two outputs. Line 220 is used for data input into signal decomposer 200. In this embodiment, lines 222 and 224 are used for data output from signal decomposer 200. Line 222 connects signal decomposer 200 with the input of first adjustable gain amplifier 206. The output of first adjustable gain amplifier 206 is then connected by line 236 to the input of first envelope detector 202. In turn, the output of first envelope detector 202 is preferably connected to the input of first amplifier 204 via line 203. The output of first amplifier 204 is then connected to the control input of first adjustable gain amplifier 206. In this embodiment, line 236 also connects the output of first adjustable gain amplifier 206 to an input of signal combiner 214.

In this embodiment, line 224 connects signal decomposer 200 with the input of second adjustable gain amplifier 212. The output of second adjustable gain amplifier 212 is then connected by line 238 to the input of second envelope detector 208. In turn, the output of second envelope detector 208 is connected to the input of second amplifier 210 via line 209. The output of second amplifier 210 is then preferably connected to the control input of second adjustable gain amplifier 212. Line 238 also preferably connects the output of second adjustable gain amplifier 212 to an input of signal combiner 214.

Signal combiner 214 preferably has at least two inputs and at least one output. As described above, lines 236 and 238 are used for input to signal combiner 214. Line 240 is used for outputs from signal combiner 214. In alternate embodiments, additional power amplifiers may be inserted at the inputs of signal combiner 214 to properly amplify the signals on lines 236 and 238 prior to combination.

In this embodiment, as in the embodiment shown in FIG. 1, the signal decomposer 200 comprises a LINC signal decomposer. However, one skilled in the art will readily appreciate that the signal decomposer may comprise any device capable of decomposing a signal into a plurality of components. Also in this embodiment, the envelope detectors 202 and 208 can comprise any device which detects the envelope of an incoming signal and including, for example, a digital signal processor (DSP) or a traditional diode-capacitor envelope detector. Furthermore, the amplifiers 204 and 210 are employed preferably for the purpose of amplifying the envelope portion of an input signal to a range acceptable for the control input of adjustable gain amplifiers 206 and 212. Accordingly, one skilled in the art will recognize that in alternate embodiments where an envelope detector outputs an envelope signal already in the range of the adjustable gain amplifiers 206, 212, the amplifiers 204 and 210 are unnecessary and are optional.

Also in the preferred embodiment, combiner 214 comprises a Chireix style amplitude combiner. In various other embodiments, combiner 214 can also comprise a conventional power combiner.

In operation, signal decomposer 200 receives a signal on input line 220 and decomposes this signal into two near-constant envelope signal components. These two near-constant envelope signals are then transmitted from signal decomposer 200 to first adjustable gain amplifier 206 and second adjustable gain amplifier 212, respectively.

In this embodiment, near-constant envelope signal is amplified by adjustable gain amplifier 206 in inverse proportion to a control signal to produce a first amplified constant envelope signal. The control signal is preferably produced when the first amplified constant envelope signal is in turn transmitted to first envelope detector 202 where its envelope is determined and amplified by first amplifier 204. The control signal is fed back by amplifier 204 along line 227 to the control input of adjustable gain amplifier 206. As the first non-constant envelope signal is amplified in inverse proportion to the control signal, which comprises the amplified envelope portion of a non-constant envelope signal, any residual amplitude modulation in the first non-constant envelope signal is effectively reduced or, more preferably, completely removed. The output of this process is a first amplified constant envelope signal.

Simultaneously, in a process symmetrical to the above, the second near-constant envelope signal is amplified by second adjustable gain amplifier 212 in inverse proportion to a control signal to produce a second amplified constant envelope signal. The control signal is preferably produced when the second amplified constant envelope signal is in turn transmitted to second envelope detector 208 where its envelope is determined and amplified by second amplifier 210. The control signal is fed back by second amplifier 210 along line 231 to the control input of second adjustable gain amplifier 212. As the second non-constant envelope signal is amplified in inverse proportion to the control signal, which comprises the amplified envelope portion of a non-constant envelope signal, any residual amplitude modulation in the second non-constant envelope signal is effectively reduced or, more preferably, completely removed. The output of this process is a second amplified constant envelope signal.

Finally, the first and second amplified constant signals are both transmitted along lines 236 and 238 to combiner 214 where the two signals are combined to produce an output signal which is output to line 240. In some embodiments, the first and second amplified constant signals are transmitted to a first and second power amplifier, respectively, before being transmitted to the combiner 214. As the output signal from combiner 214 preferably comprises the combination of the amplified components of the incoming signal along line 220, the signal output on line 240 comprises an amplified version of the incoming signal on line 220.

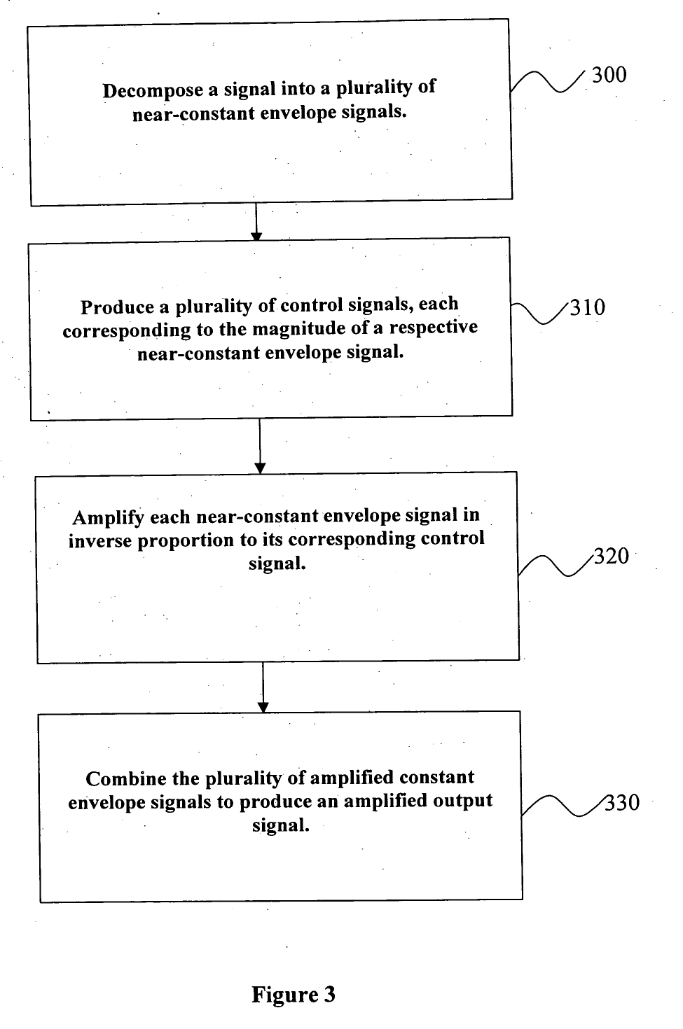

The flow diagram of FIG. 3 illustrates a method in accord with an embodiment of the present invention. In the preferred embodiment, a signal is initially decomposed into a plurality of near-constant envelope signals (Step 300). The signal is preferably decomposed through a LINC signal decomposition or a similar technique. Due to band limiting and quantization effects in the decomposition process, the component signals usually contain unwanted residual amplitude modulation, and this comprise near-constant envelope signals.

Next, a plurality of control signals, each corresponding to the magnitude of a respective near-constant envelope signal, is produced (Step 310). Each control signal preferably comprises an amplified signal bases upon the envelope of a respective near-constant envelope signal. In some embodiments, a typical envelope detector is used to detect the envelope of the near-constant envelope signal in order to produce the control signal. However, in other embodiments, a digital signal processor (DSP) may be used to detect the envelope of the near-constant envelope signals and generate a corresponding control signal.

Thirdly, each near-constant envelope signal is amplified in inverse proportion to its corresponding control signal (Step 320). This step can be performed by an adjustable gain amplifier. The resultant signal is an amplified version of the near-constant envelope signal, with reduced, and preferably eradicated, residual amplitude modulation. Accordingly, this signal preferably comprises an amplified, constant envelope signal.

Finally, the plurality of amplified constant envelope signals produced in Step 320, are preferably combined to form an output signal (Step 330). This output signal is thus a combination of amplified versions of the component amplified constant envelope signals, with their initial residual amplitude modulation reduced or, preferably, completely removed. Hence, the output signal comprises an amplified version of the original signal of Step 300. Step 330 is usually performed with a Chireix style amplitude combiner, but it may also be performed with other signal combiners, including a conventional power combiner.

It will be appreciated, by those skilled in the art, that various omissions, additions and modifications may be made to the methods and systems described above without departing from the scope of the invention. All such modifications and changes are intended to fall within the scope of the invention as illustrated by the appended claims.

1. A method for amplifying a signal comprising the steps of:
(a) decomposing a signal into a plurality of near-constant envelope signals;
(b) producing a plurality of control signals, each control signal corresponding to the magnitude of a respective near-constant envelope signal;
(c) amplifying each near-constant envelope signal in inverse proportion to its corresponding control signal;
(d) combining the plurality of inversely amplified near-constant envelope signals to produce an amplified output signal.

2. The method of claim 1 wherein decomposing the signal is accomplished through LINC signal decomposition.

3. The method of claim 1 wherein combining the signals is accomplished using a Chireix style amplitude combiner.

4. The method of claim 1 wherein combining the signals is accomplished using a conventional power combiner.

5. The method of claim 1 wherein step (c) is accomplished through the use of a variable-gain amplifier.

6. A system for amplifying a signal comprising:
a means for decomposing a signal into a plurality of near-constant envelope signals;
a means for measuring the amplitude of each near-constant envelope signal to obtain a plurality of respective control signals;
a plurality of variable amplification means for each near-constant envelope signal;
a means for combining signals;
wherein the bias of each variable amplification means is adjusted to amplify each near-constant envelope signal in inverse proportion to its respective control signal to produce a corresponding amplified constant envelope signal; and
wherein the combining means combines the plurality of amplified constant envelope signals.

7. The system of claim 6 wherein the decomposing means is LINC signal decomposition.

8. The system of claim 6 wherein the combining means is a Chireix style amplitude combiner.

9. The system of claim 6 wherein the combining means is a conventional power combiner.

10. A device for amplifying a signal comprising:
a signal decomposer;
a plurality of amplified envelope detectors;
a plurality of adjustable gain amplifiers;
a combiner;
wherein the signal decomposer fragments a signal into a plurality of near-constant envelope signals,
wherein each amplified envelope detector produces a control signal corresponding to a respective near-constant envelope signal,
wherein the gain of each adjustable gain amplifier is controlled by a respective control signal,
wherein each adjustable gain amplifier amplifies a respective near-constant envelope signal with gain inversely proportionate to its respective control signal, thereby producing an amplified constant envelope signal;
wherein the combiner combines the plurality of amplified constant envelope signals.

11. The device of claim 10 wherein the signal decomposer is a LINC signal decomposer.

12. The device of claim 10 wherein the combiner is a Chireix style amplitude combiner.

13. The device of claim 10 wherein the combiner is a conventional power combiner.

14. A method for producing an amplified signal, comprising the steps of:
decomposing a signal into a plurality of near-constant envelope signals;
obtaining a first control signal proportionate to the envelope of a first near-constant envelope signal;
inputting the first near-constant envelope signal into a first adjustable gain amplifier;
obtaining a second control signal proportionate to the envelope of a second near-constant envelope signal;
inputting the second near-constant envelope signal into a second adjustable gain amplifier;
adjusting the bias of the each adjustable gain amplifier using a respective control signal, thereby producing a plurality of amplified constant envelope signals;
combining the plurality of amplified constant envelope signals.

15. The method of claim 14 wherein decomposing the signal is accomplished through LINC signal decomposition.

16. The method of claim 14 wherein combining the signals is accomplished using a Chireix style amplitude combiner.

17. The method of claim 14 wherein combining the signals is accomplished using a conventional power combiner.

18. A device for amplifying a signal comprising:
a signal decomposer having an input terminal and a plurality of output terminals;
a plurality of adjustable gain amplifiers, each adjustable gain amplifier having an input terminal, a control terminal, and an output terminal, whereby its input terminal is in electrical communication with a respective output terminal of the signal decomposer;
a plurality of envelope detectors, each envelope detector having an input terminal and an output terminal, wherein its input terminal is in electrical communication with an output terminal of a respective adjustable gain amplifier;
a plurality of amplifiers, each amplifier having an input terminal in electrical communication with a respective envelope detector output terminal, and an output terminal in electrical communication with the control terminal of the respective adjustable gain amplifier;
a combiner having a plurality of input terminals and an output terminal, wherein each input terminal is in electrical communication with the output terminal of a respective adjustable gain amplifier.

19. The device of claim 18 wherein the signal decomposer is a LINC signal decomposer.

20. The device of claim 18 wherein the combiner is a Chireix style amplitude combiner.

21. The device of claim 18 wherein the combiner is a conventional power combiner.

22. A device for amplifying a signal comprising:
a signal decomposer having an input terminal and a plurality of output terminals;
a plurality of envelope detectors, each envelope detector having an input terminal and an output terminal, wherein the input terminal of the envelope detector is in electrical communication with a respective output terminal of the signal decomposer;
a plurality of envelope signal amplifiers, each envelope signal amplifier having an input terminal and an output terminal, wherein its input terminal is in electrical communication with the output terminal of a respective envelope detector;
a plurality of adjustable gain amplifiers, each adjustable gain amplifier having an input terminal, a control terminal, and an output terminal, wherein its control terminal is in electrical communication with the output terminal of a respective envelope signal amplifier, and whereby its input terminal is in electrical communication with a respective output terminal of the signal decomposer;
a combiner having a plurality of input terminals and an output terminal, wherein each input terminal is in electrical communication with the output terminal of a respective adjustable gain amplifier.

23. The device of claim 22 wherein the signal decomposer is a LINC signal decomposer.

24. The device of claim 22 wherein the combiner is a Chireix style amplitude combiner.

25. The device of claim 22 wherein the combiner is a conventional power combiner.
